(19) United States
(12) Patent Application Publication
(10) Pub. No.: US 2008/0194752 A1
(43) Pub. Date: Aug. 14, 2008

(54) POLYPROPYLENE RESIN COMPOSITIONS

(76) Inventors: Ki Eyoun Jeong, Suwon-si (KR); In Soo Han, Hwaseong-si (KR); Sung Min Cho, Daejeon (KR)

Correspondence Address: Ki Eyoun Jeong, 611-201, Cheongsol Maeul Jugong 6-danji, Jeongja-dong, Jangan-gu, Suwon-si, Gyeonggi-do, 440-300, omitted

(21) Appl. No.: 11/953,418

(22) Filed: Dec. 10, 2007

(30) Foreign Application Priority Data
Feb. 13, 2007 (KR) 10-2007-0015039

(51) Int. Cl. C08L 23/12; C08K 3/22; C08K 3/34; C08K 3/10

(52) U.S. Cl. 524/427; 524/528; 524/451; 524/449; 524/445; 524/433

(57) ABSTRACT

The present invention provides a polypropylene resin composition prepared by mixing a polypropylene master batch, a high crystalline polypropylene, an ethylene-styrene copolymer rubber, an ethylene-α-olefin rubber and an inorganic filler. The polypropylene resin produced has reduced swirl marks, superior melting tension, fluidity, foaming magnitude, impact resistance, and cooling rate, and is useful for construction of vehicle interior parts.

### CROSS-REFERENCE TO RELATED APPLICATIONS

This application claims the benefit under 35 U.S.C. §119(a) of Korean Patent Application No. 10-2007-0015039, filed in the Korean Intellectual Property Office on Feb. 13, 2007, the disclosure of which are incorporated herein by reference in its entirety,

### FIELD OF THE INVENTION

The present invention relates to polypropylene resin compositions, and more particularly to polypropylene resin compositions with improved melting tension, fluidity, cooling rate, foaming magnitude and impact resistance.

### BACKGROUND OF THE INVENTION

Under the Vehicle Collision Regulation and the Pedestrian Protection Act, interior parts of vehicles should have superior impact resistance, rigidity, heat resistance and scratch resistance. Concurrently, the Kyoto Protocol has placed limits on the production of carbon dioxide which occurs in plastic foaming processes. Interior parts can be formed from polypropylene-based materials by injecting the materials into a mold, foaming the material, then cooling the foamed material.

The fluidity and melting tension of the material are inversely proportional to one another and affect its injection molding property. In effect, a high fluidity which should improve the injection molding property would lower the molecular weight and melting tension. A high molecular weight, which would increase the melting tension, may in turn lower the fluidity and the injection molding property. As compared to other resins, polypropylene resin has a lower melting tension since its linear chain structure increases the resistance of a melt material during the melt-elongation and thus may prevent the increase of elongation viscosity, as characteristic of the strain hardening phenomenon.

In the prior art, even when the base resin, ethylene-α-olefin copolymer rubber components and inorganic additives are appropriately mixed, the resulting products are frequently beset by a number of problems, such as prominent swirl marks, and low Loam magnitude and impact strength, thus failing to satisfy the Vehicle Collision Regulation, the Pedestrian Protection Act and other requirements of vehicle interior parts. Conventional polypropylene resin compositions which employ ethylene-α-olefin copolymer rubber and an inorganic filler likewise suffer from some of these same problems.

Swirl marks is a phenomenon observed when foam cells break and gas flow to the surface results in wave patterns on the surface of the foamed articles. There are several ways to prevent formation of swirl marks, e.g. by increasing melting tension of the resin and thus preventing gas flow to the surface and/or by speeding up the cooling rate so as to complete the cooling before the foam cells break. The low foaming magnitude is caused by a decrease in melting tension from the presence of the ethylene-α-olefin copolymer rubber and inorganic additives. The decrease in impact strength and resistance is due to the coarse structure of foam cells from decreased melting tension.

In light of the above, there is a need in the art for a polypropylene resin composition that is conducive to reducing or eliminating swirl marks on the formed products and producing articles with high expansion ratio and impact resistance. The present invention provides a solution by delivering a polypropylene resin composition with superior melting tension, fluidity, cooling rate, foaming magnitude and impact resistance. Superior melting tension can be achieved even with the use of standard extrusion processes, enabling a continuous and stable process wherein a conventional extruder is used. The melting tension of polypropylene is enhanced through the use of organic peroxide having a predetermined half-life temperature to produce an improved polypropylene master batch resin. The appearance of swirl marks is also reduced or eliminated on the surfaces of products made up the polypropylene resin compositions disclosed herein.

### SUMMARY OF THE INVENTION

The present invention provides a polypropylene resin composition comprising about 5-20 wt % of a polypropylene master batch; about 35-60 wt % of a high crystalline polypropylene resin having a melt index of from about 30 to about 60 g/10 min at 230° C. and an isotacticity of about 99-100%; about 5-15 wt % of an ethylene-styrene copolymer rubber having a styrene content of 20-50 wt %, a molecular weight distribution of from about 8 to about 12 and a melt index of from about 10 to about 30 g/10 min at 230° C.; about 5-15 wt % of an ethylene-α-olefin copolymer rubber; and about 5-20 wt % of an inorganic filler Within the polypropylene master batch is a member selected from a propylene homopolymer, a propylene-ethylene copolymer, and mixtures thereof.

### DETAILED DESCRIPTION OF THE INVENTION

Before the present invention is described it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

The present invention provides a polypropylene resin composition comprising about 5-20 wt % of a polypropylene master batch; about 35-60 wt % of a high crystalline polypropylene resin having a melt index of from about 30 to about 60 g/10 min at 230° C. and an isotacticity of about 99-100%; about 5-15 wt % of an ethylene-styrene copolymer rubber having a styrene content of 20-50 wt %, a molecular weight distribution of from about 8 to about 12 and a melt index of from about 10 to about 30 g/10 min at 230° C.; about 5-15 wt % of an ethylene-α-olefin copolymer rubber; and about 5-20 wt % of an inorganic filler. Within the polypropylene master batch is a member selected from a propylene homopolymer, a propylene-ethylene copolymer, and mixtures thereof.

According to the present invention, a polypropylene master batch, a high crystalline polypropylene resin, an ethylene-styrene copolymer rubber, an ethylene-α-olefin copolymer rubber and an inorganic filler are mixed, then injected into a mold. The minimization of swirl marks is achieved due to the high expansion ratio. Furthermore, the improved melting tension, fluidity, cooling rate and impact resistance are characteristics which make the composition of the present invention useful in the manufacture of vehicle parts, such as, without limitation, a door trim base.

A polypropylene master batch, as used herein, may comprise a propylene homopolymer, a propylene-ethylene copolymer, or mixtures thereof. In preferred embodiments, the polypropylene master batch can be derived by (a) mixing about 95-99 wt % of high crystalline polypropylene having melt index of about 30-60 g/10 min (230° C.) and isotacticity of about 99-100% and about 1-5 wt % of organic peroxide having 10-hour half-life temperature of less than about 60° C., preferably less than 40° C., (b) extruding the mixture at about 190-250° C. and (c) cooling and solidifying the extrudate into a pellet.

A melt index of less than about 30 g/10 min (230° C.) would cause the high crystalline polypropylene, which is in the polypropylene master batch, to exhibit poor injection molding property due to low fluidity. In contrast, a melt index that exceeds about 60 g/10 min (230° C.) would lower the foaming property due to low melting tension. When the high crystalline polypropylene has less than about 99% isotacticitv, swirl marks are apt to occur due to the low cooling rate. When the high crystalline polypropylene falls below about 95 wt % of the overall composition, excessive crosslinking will result from the relatively high peroxide content, and extrusion is difficult due to melt fracture. Higher than about 99 wt % of high c stalline polypropylene would lower the melting tension due to the relatively low content of organic peroxide.

Organic peroxide having a 10-hour half-life temperature of less than about 30° C. is too explosive for safe handling whereas higher than about 60° C. would not result in sufficient melting tension due to the relatively few long side chains. Likewise, where the content of the organic peroxide is less than about 1 wt % of the composition, melting tension may not be sufficient due to few long side chains in the polypropylene, thus lowering the foaming magnitude and generating swirl marks. On the other hand, higher than about 5 wt % would lower the fluidity and injection molding property from too many side chains in the structure. Although any organic peroxide with the aforementioned half-life temperature may be used in the present invention, diisobutylperoxide is preferred.

Extrusion of the high crystalline polypropylene and organic peroxide mixture at temperatures of less than about 190° C. would not introduce sufficient amount of long side chains due to low reaction rate of organic peroxide. Temperatures exceeding about 250° C. can lower the melting tension, drastically increase the reaction rate and cause the polypropylene to partially decompose.

In preferred embodiments, the polypropylene master batch is prepared using high crystalline polypropylene instead of conventional polypropylene to produce long chain structure with high crystallinity and high melting tension. The cooling rate may result from the high crystallinity, and swirl marks reduced and foaming magnitude increased due to the high melting tension.

In some embodiments, the polypropylene master batch is used in the amount of about 5-20 wt %. Less than about 5 wt % would make the occurrence of swirl marks more likely. When the content is higher than about 20 wt %, the injection molding property may be lowered due to low fluidity,

In preferred embodiments, high crystalline polypropylene with high fluidity is used to increase fluidity and cooling rate. Preferably, propylene homopolymer or propylene-ethylene copolymer having a melt index of about 60-100 g/10 min (230° C.) and isotacticity of 99-100% is used. When the melt index is higher than 100 g/10 mim (230° C.), the foaming property may be lowered due to low melting tension. When the isotacticity is less than about 99%, the cooling rate may be lowered and swirl marks may be observed.

In preferred embodiments of the polypropylene resin composition of the present invention, about 35-60 wt % of high crystalline polypropylene resin is used since at less than about 35 wt %, the fluiditv, cooling rate and injection inolding property drops, and swirl marks are formed. When the amount is higher than 60 wt %, the foaming magnitude deteriorates due to low melting tension.

In some embodiments of the invention, the ethylene-styrene copolymer rubber used should have about 20-50 wt % of styrene. This copolymer rubber, having a molecular weight distribution of about 8-12 and a melt index of about 10-30 g/10 min is used herein to enhance melting tension, fluidity and impact strength. This copolymer rubber can be prepared using novel nickel-based catalyst nickel instead of conventional vanadium-based catalyst, and has a very broad molecular weight distribution and superior melting tension and fluidity. Although melting tension is typically inversely proportional to fluidity, the styrene-ethylene copolymer rubber is superior in both melting tension and fluidity due to the broad molecular weight distribution. Further, the styrene-based copolymer rubber also has superior impact strength thus avoiding the low impact strength characteristic of conventional injection foamed products.

Styrene content of less than about 20 wt % would lower the melting tension whereas an excess of about 50 wt % would lower the impact strength. When the molecular weight distribution is less than 8, the melting tension may be lowered. Although the melting tension may be enhanced as a side-effect of increased molecular weight distribution, practical considerations associated with conventional catalyst techniques relegate the maximum achievable molecular weight of the styrene-based copolymer rubber to about 12. When the melt index is less than about 10 g/10 min (230° C.), the injection molding property is lowered. When the melt index is higher than 30 g/10 min (230° C.), the melting tension is lowered.

In preferred embodiments of the invention, about 5-15 wt % of ethylene-styrene copolymer rubber is used. When the amount is less than about 5 wt %, the melting tension may not be sufficient. When the amount is higher than 15 wt %, the overall cost-efficiency is impacted due to the increase in prime cost from the high weight percentage of rubber. Additionally, too much ethylene-styrene copolymer rubber results in reduced impact strength.

The ethylene-α-olefin copolymer rubber used herein is less expensive than ethylene-styrene copolymer rubber, which helps lower the relatively high prime cost of the ethylene-styrene copolymer needed to enhance impact resistance of the resulting composition.

The ethylene-α-olefin copolymer rubber is a copolymer of ethylene and α-olefin. Examples of the α-olefin include propylene, butene, pentene, hexene, propene and octane. Examples of the ethylene-α-olefin copolymer rubber include ethylene-propylene rubber (EPR), ethylene-propylene-diene rubber (EPDM), ethylene-octene rubber (EOR) and mixtures thereof. Among them, ethylene-octene rubber is most preferred since octane, a co-monomer, has a long side chain and superior impact resistance at low temperatures. The α-olefin content in the ethylene-α-olefin copolymer rubber is preferably about 10-30 wt % since too low a weight percentage would cause the melting tension to suffer and too high a content would cause the impact strength to deteriorate.

In preferred embodiments, about 5-15 wt % of ethylene-α-olefin copolymer rubber is used. When the amount is less than about 5 wt %. the low-temperature impact strength may be impacted. When the amount is higher than about 15 wt %, the melting tension and the injection molding property may be lowered.

In the present invention, an inorganic filler serves to enhance dimension stability, rigidity and cooling rate. Examples of an inorganic filler suitable for use with the present invention include, without limitation, talc, calcium carbonate, calcium sulfate, magnesium oxide, calcium stearate, mica, silica, calcium silicate, clay, carbon black and mixtures thereof. Among them, talc with an average particle diameter of 2-20 μm is most preferred. The inorganic filler is preferred to be used in the amount of about 5-20 wt % of the composition as a whole. When the amount is less than about 5 wt %, the dimension stability and the rigidity may not be satisfactory. When the amount is higher than 20 wt %, the impact strength and the melting tension may be lowered.

A polypropylene resin composition in the present invention can be prepared using any conventional method known to those of ordinary skill in the art. Pellets can be prepared, for instance, by extruding the mixture at about 190-250° C., followed by cooling and solidifying the extrudate.

### EXAMPLES

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for.

### Preparatory Example 1

For the first Preparatory Example, 3 wt % of organic peroxide diisobutylperoxide having 10-hour half-life temperature of 40° C. was mixed with 97 wt % of high crystalline polypropylene resin having ethylene content of 8 wt %, melt index of 35 g/10 min (230° C.), and isotacticity of 99%. The mixture was extruded using an extruder at 220° C., and cooled and solidified, and formed into pellets.

### Comparative Preparatory Example 1

For the first Comparative Preparatory Example, 3 wt % of organic peroxide dicumylperoxide having 10-hour half-life temperature of 100° C. was mixed with 97 wt % of polypropylene resin having ethylene content of 8 wt %, melt index of 35 g/10 min (230° C.), and isotacticity of 96%. The mixture was extruded using an extruder at 220° C., and cooled and solidified, and formed into pellets.

### Examples 1-3 and Comparative Examples 1-5

Compositions were prepared using the components as shown in Table 1. Test results of the Experimental Examples are shown in Table 2.

TABLE 1

| | A | A-1 | B | B-1 | C | D | E |
|---|---|---|---|---|---|---|---|
| Ex. 1 | 15 | — | 50 | — | 10 | 10 | 15 |
| Ex. 2 | 5 | — | 60 | — | 10 | 10 | 15 |
| Ex. 3 | 20 | — | 45 | — | 10 | 10 | 15 |
| Ex. 4 | 15 | — | 50 | — | 5 | 15 | 15 |
| Ex. 5 | 15 | — | 50 | — | 15 | 5 | 15 |
| Comp. Ex. 1 | — | 15 | 50 | — | 10 | 10 | 15 |
| Comp. Ex. 2 | 15 | — | — | 50 | 10 | 10 | 15 |
| Comp. Ex. 3 | 30 | — | 35 | — | 10 | 10 | 15 |
| Comp. Ex. 4 | 15 | — | 50 | — | 20 | — | 15 |
| Comp. Ex. 5 | 15 | — | 50 | — | — | 20 | 15 |

A component: Preparatory Example 1
A-1 component: Comparative Preparatory Example 1
B component: High crystalline polypropylene resin (ethylene content of 8 wt %, melt index of 35 g/10 min and isotacticity of 99%)
B-1 component: Typical polypropylene resin (Honam Petrochemical Corp., ethylene content of 8 wt %, melt index 35 g/10 min and isotacticity of 96%)
C component: Highly fluid ethylene-styrene copolymer rubber with high melting tension (styrene content of 40 wt %, molecular weight distribution of 9.8 and melt index of 22 g/10 min)
D component: Ethylene-octene copolymer rubber (octene content of 20 wt %)
E component: Talc (average particle diameter of 5 μm)

### EXPERIMENTAL EXAMPLE

### 1. Swirl Mark

Injection molding was performed using a mold (50 cm×50 cm×3 mm) and an electric-motored injection molder (UBE 850 TON) according to the core-back method. The surface was observed with the naked eye, and the presence of wave patterns or swirl marks was noted.

### 2. Melt Index (MI)

The injection molding property was evaluated using melt index (‘MI’ hereinafter). When the melt index is higher than 30 g/10 min, molding is rated as possible. The melt as measured according to ASTM D-1238 (230° C. and 2.16 kg_{f}).

### 3. Impact Resistance

The injection foam molded product was subject to measurements for DuPont impact strength at room temperature. When the room-temperature impact strength is higher than 50 kg_{f}.cm, the molded product was determined as satisfactory based on the requirements of Side Collision Test, thus being applicable to a vehicle interior part. When the value is less than 50 kg_{f}.cm, the product was determined as failing to qualify for use as a vehicle interior part. The DuPont impact strength was measured according to JIS K 6718 method.

### 4. Foaming Property

Foaming property was evaluated using melting tension (‘MT’ hereinafter). MT value was measured using Rheotense 71.97 device (Geeffert, Germany). Resin was placed in a uniaxial extruder (Brabender, Germany), and extruded at 220° C. and 50 rpm, and the MT value was measured with a rheotense equipped under the plate. The rheotense is equipped with 4 wheels for the elongation of resin. Elongation was conducted at a constant rate. The measured value is expressed in cN, and the foaming property determined as superior when the value is higher than 10 cN.

TABLE 2

| | | | | Foaming |
|---|---|---|---|---|
| | Swirl | Melt index (MI) | Impact resistance | property |
| | mark | (g/10 min) | (kg_{f} · cm) | (cN) |
| Ex. 1 | No | 36 | 62 | 21 |
| Ex. 2 | No | 42 | 57 | 13 |
| Ex. 3 | No | 32 | 63 | 32 |
| Ex. 4 | No | 34 | 59 | 17 |
| Ex. 5 | No | 33 | 60 | 29 |
| Comp. Ex. 1 | Yes | 57 | 54 | 4 |
| Comp. Ex. 2 | Yes | 37 | 55 | 22 |
| Comp. Ex. 3 | No | 21 | 52 | 29 |
| Comp. Ex. 4 | Yes | 33 | 45 | 31 |
| Comp. Ex. 5 | Yes | 34 | 48 | 8 |

As shown in Table 2, the resin compositions prepared in Examples 1-3 showed less appearance of swirl marks than those prepared in Comparative Examples 1-5. Further, the compositions herein showed equivalent mechanical properties such as injection molding property, impact resistance and foaming property as compared to conventional injection-molded polypropylene resins.

As evidenced above, the polypropylene resin composition of the present invention shows less swirl marks than conventional injection-molded polypropylene resin compositions. The compositions herein are at least comparable in their mechanical properties, e.g. injection molding property, impact resistance and foaming property, etc., as conventional injection-molded polypropylene resin. The advantages of the present invention make it particularly suited to the manufacture of vehicle parts, ultimately creating a more lightweight vehicle to thereby increase fuel efficiency, and reducing the production of carbon dioxide to thereby countering the trend towards global warming.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A polypropylene resin composition comprising:
(a) about 5-20 wt % of a polypropylene master batch comprising a propylene homopolymer, a propylene-ethylene copolymer, or mixtures thereof;
(b) about 35-60 wt % of a high crystalline polypropylene resin having a melt index of from about 30 to about 60 g/10 min at 230° C. and an isotacticity of about 99-100%;
(c) about 5-15 wt % of an ethylene-styrene copolymer rubber having a styrene content of about 20-50 wt %, a molecular weight distribution of from about 8 to about 12 and a melt index of from about 10 to about 30 g/10 min at 230° C.;
(d) about 5-15 wt % of an ethylene-α-olefin copolymer rubber; and
(e) about 5-20 wt % of an inorganic filler.

2. The polypropylene resin composition of claim 1, wherein the polypropylene master batch is prepared by a method comprising the steps of:
(a) mixing about 95-99 wt % of a high crystalline polypropylene having a melt index of about 60-100 g/10 min (230° C.) and an isotacticity of about 99-100% and about 1-5 wt % of an organic peroxide having 10-hour half-life temperature of about 30-60° C.;
(b) extruding the mixture using an extruder at about 190-250° C.; and
(c) cooling and solidifying the extrudate.

3. The polypropylene resin composition of claim 2 wherein the organic peroxide is diisobutylperoxide.

4. The polypropylene resin composition of claim 1, wherein the ethylene-α-olefin copolymer rubber has an α-olefin content of about 10-30 wt %.

5. The polypropylene resin composition of claim 1, wherein the inorganic filler is selected from the group consisting of talc, calcium carbonate, calcium sulfate, magnesium oxide, calcium stearate, mica, calcium silicate, clay, carbon black and mixtures thereof.
